(19) United States
(12) Patent Application Publication
(10) Pub. No.: US 2011/0285726 A1
(43) Pub. Date: Nov. 24, 2011

(54) Method and apparatus for preparing subtitles for display

(76) Inventor: William Gibbens Redmann, Glendale, CA (US)

(21) Appl. No.: 13/138,364

(22) PCT Filed: Feb. 18, 2009
(86) PCT No.: PCT/US09/01014

§ 371 Date: Aug. 5, 2011

(51) Int. Cl. G06T 11/00

(52) U.S. Cl. 345/467

(57) ABSTRACT

A method and apparatus for preparing subtitles for display are disclosed. Embodiments provide a method and apparatus for preparing at least one subtitle for display based on at least one parameter measured using an image shown on a screen.

### TECHNICAL FIELD

This invention relates to subtitle display in digital media presentations.

### BACKGROUND

In digital cinema presentations, subtitles are digitally rendered and composited into the projected image by a digital cinema server or projector in accordance with positioning instructions incorporated into the digital cinema composition playlist. However, the one-size-fits-all positioning instructions created by studios or post-production houses cannot account for extremes in variance of projection geometry that may be encountered in exhibition auditoriums, and may result in subtitles being clipped by edges of projection screen or masking.

The current practice for creating positioning instructions is to inset subtitles from each side by 10% of the width of the image, and from the top and bottom by 10% of the height of the image. In some cases, where the subtitle is particularly large, or some portion of the image is particularly important and would otherwise be obstructed by the subtitles, then the inset value from the edge may be reduced to 5%.

### SUMMARY OF THE INVENTION

Embodiments of the present invention provide a method and apparatus for preparing a subtitle for display in digital media presentations without the subtitle being clipped.

One embodiment provides a method for use in subtitle display, which includes determining at least one parameter from a first image displayed on a screen, the at least one parameter relating to one of a position and dimension to be used for displaying a first subtitle, and preparing the first subtitle for display on the screen based on the at least one parameter.

Another embodiment provides an apparatus, which includes a screen, a projector, a first image for displaying on the screen for determining at least one parameter, the at least one parameter relating to at least one of a position and a dimension to be used for displaying the first subtitle on the screen, and a processor for preparing a first subtitle for display on the screen based on the at least one parameter.

Another embodiment provides an apparatus that includes a display means, means for determining at least one parameter relating to at least one of a position and a dimension to be used for displaying a subtitle, the determining means including an image for display on the display means, and means for preparing the subtitle for display based on the at least one parameter.

### BRIEF DESCRIPTION OF THE DRAWING

The teachings of the present invention can be readily understood by considering the following detailed description in conjunction with the accompanying drawings, in which:

FIG. 1 illustrates a visual composition that includes a picture or image essence overlaid with a subtitle;

FIG. 2 is a schematic illustration of cropping of a projected image of FIG. 1 during media presentation;

FIG. 3 is a schematic illustration of a projected image with a keystone shape;

FIG. 4 is a schematic illustration of cropping of the keystone-shaped projected image of FIG. 3 during media presentation;

FIG. 5 illustrates a visual composition with the subtitle being modified according to one embodiment of the present principles to avoid cropping;

FIG. 6 illustrates a visual composition with the subtitle being modified according to another embodiment of the present principles to avoid cropping.

FIG. 7a illustrates a test pattern for use in determining parameters related to subtitle display;

FIG. 7b is a schematic illustration of the test pattern of FIG. 7a being projected on a screen;

FIG. 7c shows an expanded view of the projection of the test pattern of FIG. 7a relative to the screen;

FIGS. 7d and 7e show other views of the projection of the test pattern of FIG. 7a relative to the screen, depending upon projection geometry;

FIG. 8a illustrates another test image for use in determining parameters related to subtitle displays;

FIG. 8b illustrates yet another embodiment for determining parameters related to subtitle displays;

FIG. 9 illustrates one embodiment of an apparatus for use in implementing subtitle displays;

FIG. 10 is a flowchart illustrating a method for producing a subtitle display in accordance with one or more embodiments of the present principles; and,

FIG. 11 is a flowchart illustrating another method for producing a subtitle display in accordance with one or more embodiments of the present principles.

To facilitate understanding, identical reference numerals have been used, where possible, to designate identical elements that are common to the figures.

### DETAILED DESCRIPTION

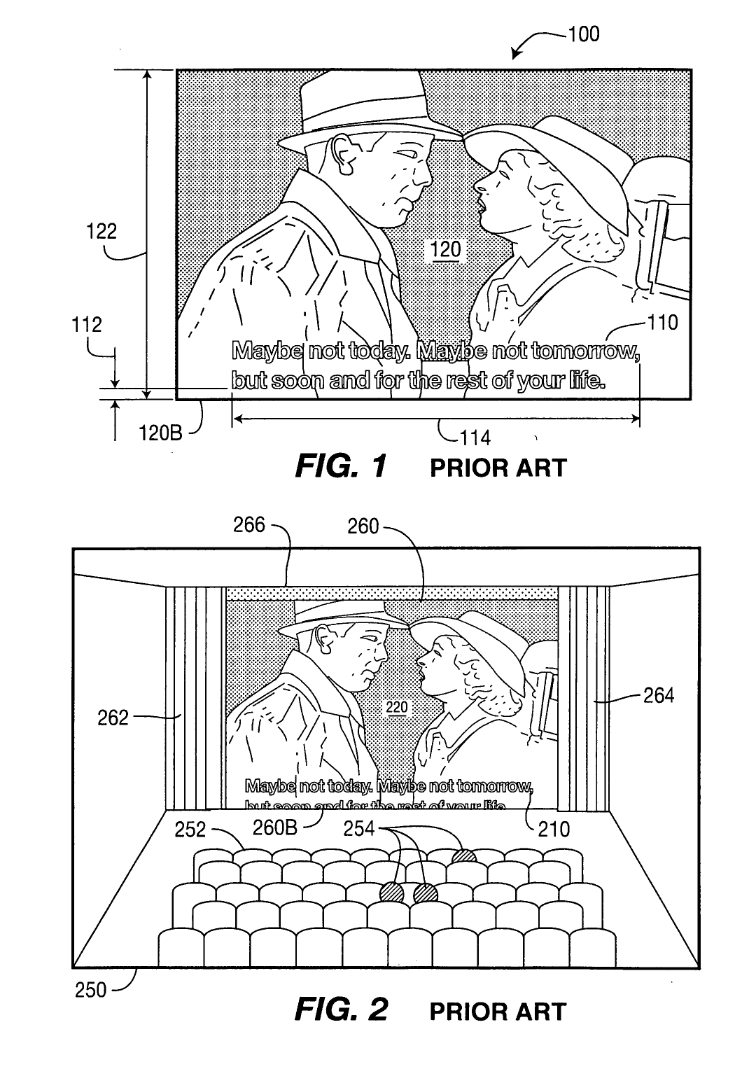

FIG. 1 depicts a visual composition 100 that includes an image or picture 120 overlaid with subtitle 110. This composition 100 corresponds to the image 120 and subtitle 110 as provided in an image data file. As used herein, the word “image” or “picture” also includes image essence as used in the context of digital cinema (the word “essence” is defined as “image, audio, subtitles, or any content that is presented to a human being in a presentation,” see DCI Digital Cinema System Specification, v1.0, Jul. 20, 2005; or “that part of the program data representing the image, audio or text that is directly presented to the audience,” see The EDCF Guide to Digital Cinema Mastering, p. 25, August 2007, European Digital Cinema Forum).

In this example, instructions used to direct the overlay of subtitle 110 onto picture 120 may specify the subtitle 110 to be horizontally centered with respect to picture 120 with the bottom of the subtitle 110 being located at a vertical position or height 112 measured from the bottom 120B of the image 120 (this vertical position of the subtitle's bottom may also be referred to as a “bottom height” of the subtitle 110). This vertical position for the subtitle is usually expressed as a percentage equal to the ratio of the vertical position 112 to the height 122 of picture 120. Such a description of a subtitle and its position are well-known and described in standards, such as 429-5 Digital Cinema Package Subtitle Track File, published by the Society of Motion Picture and Television Engineers, White Plains, N.Y. The subtitle 110 has a width 114 representing the maximum horizontal extent (e.g., difference between the left-most and right-most coordinates of the subtitle 110).

FIG. 2 depicts a schematic view of the image of FIG. 1 being projected onto a screen during a media presentation in an auditorium 250, which includes a seating area 252 for audience 254 and a screen 260. Masking are typically used to mask off outer portions of the screen 260 so as to provide a display area conforming to the aspect ratio or format of a movie, or to mask off areas with optical distortions, and so on. Most auditoriums have either only top masking or only side masking, but some have top and side masking, and a few auditoriums have four-way masking that includes a bottom mask (not shown). In this example, the display area of the screen 260 is bounded on three sides by side masking 262 on the left, side masking 264 on the right, top masking 266, and by bottom edge 260B. In a well-configured auditorium, the masking 262, 264 and 266 are set to permit a projected image 220 of maximum possible size on screen 260 that is consistent with the projection geometry of the auditorium 250 and aspect ratio of the image to be displayed.

However, the display area of the screen 260 does not always coincide with the area occupied by the entire projected image of the picture 120. In the example of FIG. 2, the picture 120, when projected onto screen 260, is larger than the display area. Thus, an outer portion of picture 120 (including a portion near the bottom 120B) is not visible in the display area, and the subtitle 210 is also clipped by a bottom edge 260B of the screen 260.

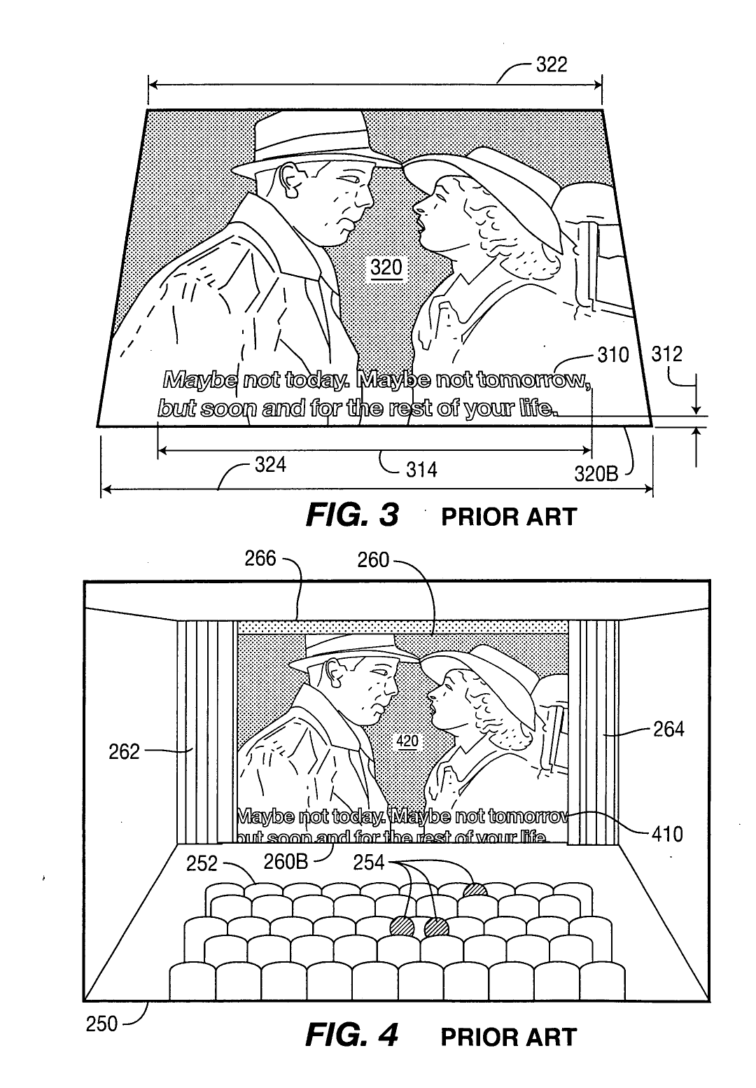

FIG. 3 shows a projected image 320 having a keystone shape resulting from the projection geometry of auditorium 250. In this case, the magnification of the projected image is greater at the bottom than at the top, resulting in the image 320 having a bottom width 324 being larger than a top width 322. The subtitle 310 is also magnified in this case, with a width 314 that is larger than width 114, and its bottom-most extent being offset from the bottom edge 320B of the image 320 by a bottom height 312 that is smaller than height 112.

This keystoning effect occurs most frequently in auditoriums having a stadium-seating configuration in which the projector is located above the center height of screen 260, i.e., the vertical position at the center of the screen or half-height, such that the optical projection axis is tilted down in the direction of the screen, and there is insufficient compensation made or available by offsetting the projector lens with respect to the optical centerline of the projector internal optical axis.

FIG. 4 shows a scenario in auditorium 250, in which the keystone-shaped projected image 320 of FIG. 3 is cropped on four sides by the side masks 262, 264, top mask 266, and the bottom edge 260B of screen 260. Thus, the resulting cropped image 420 appears rectangular instead of keystone-shaped. However, the magnified subtitle 310 is also clipped by side masks 262, 264 and the screen's bottom edge 260B, resulting in a clipped subtitle 410. Note that even though this example shows the magnified subtitle 310 as being clipped by side masks 262, 264, it is possible that in other screen configurations, the left and/or right side of the subtitle 310 may be clipped by a left and/or right edge (not shown) of the screen 260. Thus, for the purpose of discussions relating to the clipping of subtitles, the mask and the edge of a screen may be considered interchangeable.

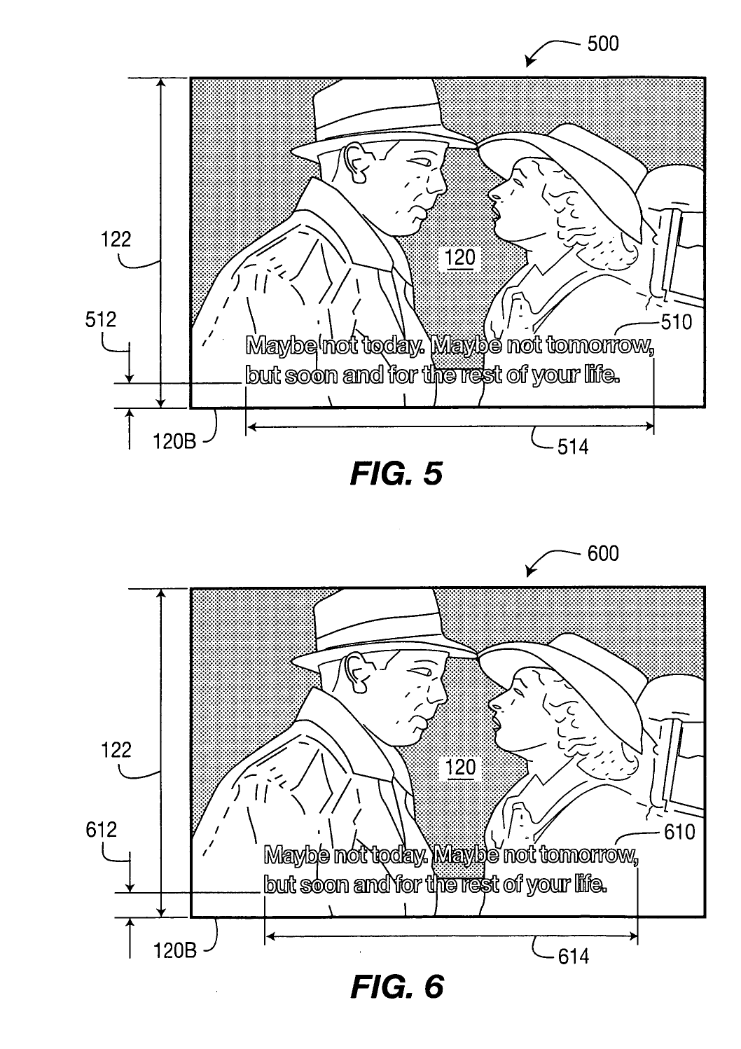

FIG. 5 illustrates a modified subtitle in an image data file in accordance with one embodiment of the present principles, which can be used to avoid the subtitle clipping problem such as that in FIG. 2. In this case, the subtitle 110 with an original bottom height 112 (i.e., as provided in the image file of FIG. 1) is transformed into a modified subtitle 510 having an increased bottom height 512 (measured from the bottom of the image 120) that is larger than the original height 112. Specifically, the transformed bottom height 512 is sufficient to ensure that, when projected or displayed, modified subtitle 510 will not be clipped by the bottom edge 260B of the screen 260. Modified subtitle 510 is superimposed onto an image, e.g., picture 120, to produce visual composition 500.

Such a transformation is made, for example, by setting the bottom height of the subtitle to be at least equal to a reference value whenever the original bottom height is less than the reference value. This reference value can be determined in a calibration method (to be described later), which is used to measure any intrusion of the screen's edge or masking into the image space. In this case, the width 514 of the subtitle 510 remains the same as width 114 of the subtitle 110.

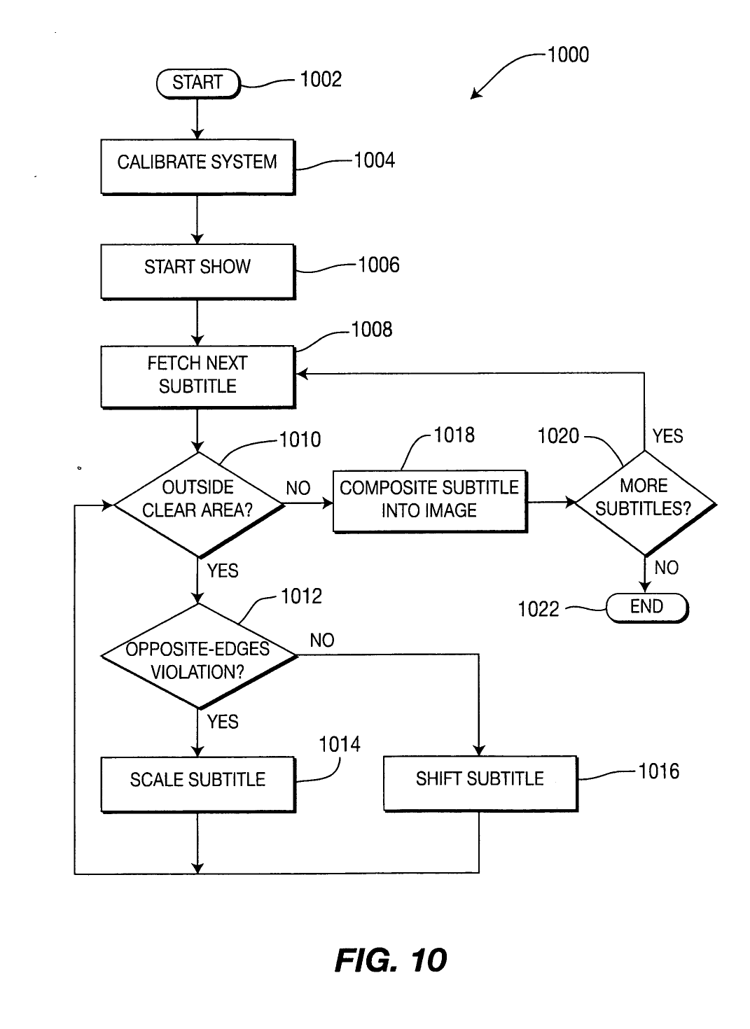

Although having the bottom height 512 at the reference value is sufficient to ensure a “safe” subtitle display (i.e., without clipping), there may be situations in which it is desirable to set the bottom height 512 to be larger than the reference value, for example, if additional subtitles (not shown) are also present (this is discussed in more detail in conjunction with FIG. 10).

FIG. 6 shows an alternative embodiment of producing a subtitle in a visual composition in an image data file. In this example, visual composition 600 is produced by overlaying an image, e.g., picture 120, with a modified subtitle 610, which is obtained by scaling subtitle 110 from its original width 114 to a width 614 that is equal to or less than a predetermined or reference value, also referred to as a reference width. Similar to the reference value for the bottom height of the subtitle, the reference width can also be determined using the calibration method to be discussed. This reference width corresponds to an upper limit for the subtitle width, i.e., a maximum width that when projected or displayed, will not be clipped by side masking 262 or 264, and may be expressed, in an image coordinate system, as a number of pixels or as a percentage of width of the image.

In general, the positioning of the bottom height (e.g., height 612) of a modified subtitle can result from one or more different transformation procedures applied to the subtitle. In one embodiment, the subtitle can be transformed by scaling it to result in an overall reduction in size of the subtitle. For example, the subtitle's physical or areal extent (e.g., characterized by the subtitle's maximum width and maximum height) can be scaled down in two dimensions, resulting in a reduction in its horizontal and vertical extents. Such a scaling operation will result in an increase of the original bottom height 112 to the modified height 612, i.e., a larger offset from the bottom of the image 120. In general, the scaling factor can have a value equal to or less than the reference width divided by the original width of the subtitle. The scaling can be done by applying a single scaling factor to both dimensions, or using different scaling factors for the horizontal and vertical dimensions, respectively (including for example, scaling a width or height alone, if desired).

Alternatively, the bottom height may also be increased by a “shifting” transformation such as that shown in FIG. 5, e.g., translating the subtitle in a vertical direction, away from the bottom of the image 120. In general, a subtitle can be re-positioned by using scaling or translation (in one or two directions) alone, or in combination.

The 2-dimensional scaling approach illustrated in visual composition 600 has the advantage that it can avoid potential cropping in both the vertical and horizontal dimensions. Thus, even when projected with the severe keystoning effect such as that in FIG. 3, the modified subtitle 610, when projected in auditorium 200, can avoid being clipped by side masking 262, 264, or the bottom 260B of screen 260.

In the above examples, discussions are directed towards a subtitle that is too close to the bottom and/or the left and right sides of the image, such that the subtitle becomes clipped when projected onto the screen (e.g., FIG. 2 and FIG. 4). Those skilled in the art will recognize that principles described herein can be adapted for subtitles that are positioned too close to the top of the image, or too tall (i.e., having a total projected height larger than that of the clear portion of the screen) and thus, may be clipped at the top and bottom, as may occur in vertically arrayed characters in Asian languages such as Chinese, Japanese (i.e., Kanji), or Korean.

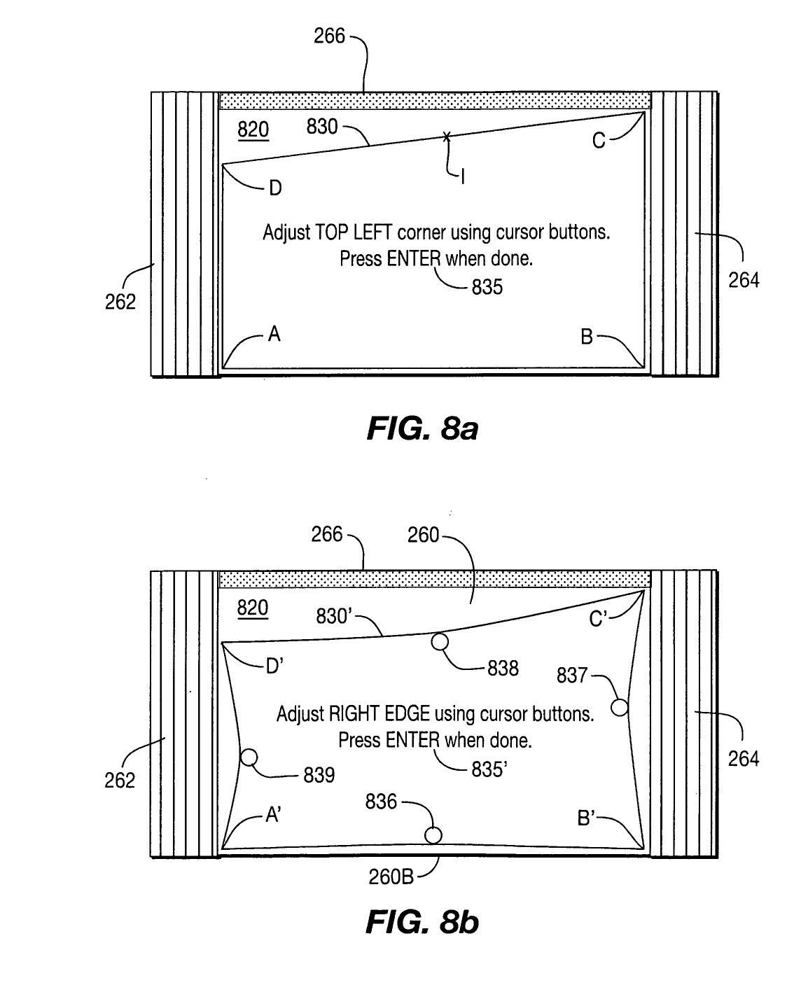

Thus, in general, to prepare a subtitle for display according to one or more embodiments of the present principles, a subtitle can be translated along a vertical or horizontal direction, or it can be scaled so that each of its outermost extents, i.e., top, bottom, left and right, is offset from the corresponding edge of the image by an amount at least equal to a reference value, which can be determined for the specific screen configuration and projection geometry. The reference value, or minimum offset from each edge of the image may be the same or different from each other. Further, if certain distortions become significant, the reference value may vary several times or continuously along each edge of the image, as discussed in conjunction with FIG. 8b.

In the example of FIG. 6, where the subtitle is scaled to avoid cropping, another predetermined or reference value can be defined for use as an upper limit of the subtitle's width (e.g., width 614). For subtitles with a vertical orientation such as those written from top to bottom, it may also be useful to define a reference value for use as an upper limit of the subtitle's height.

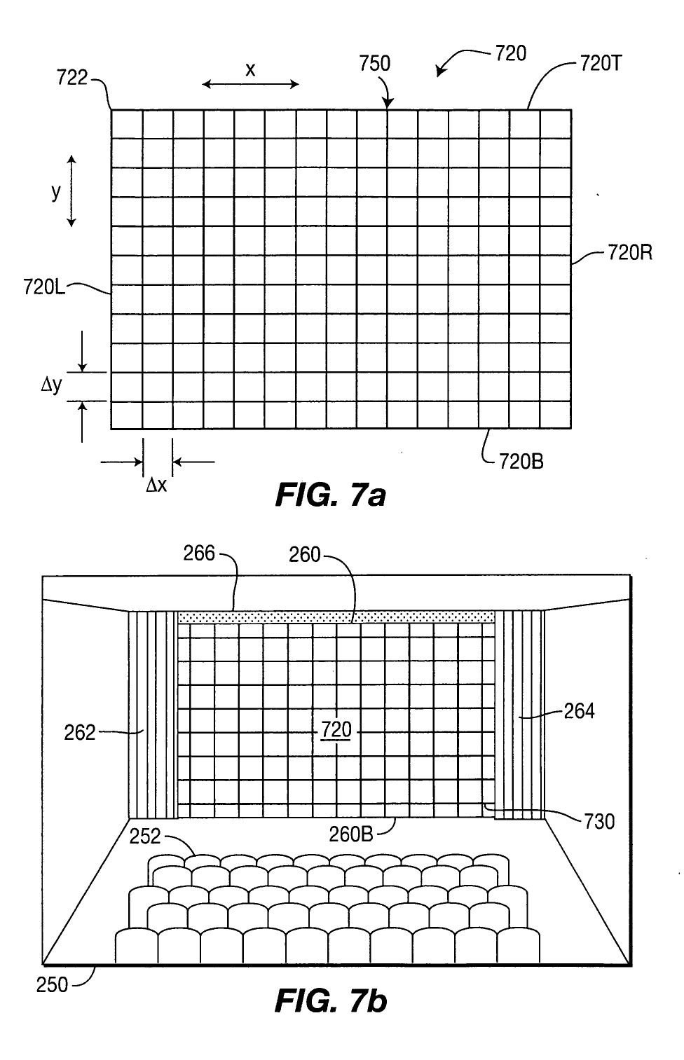

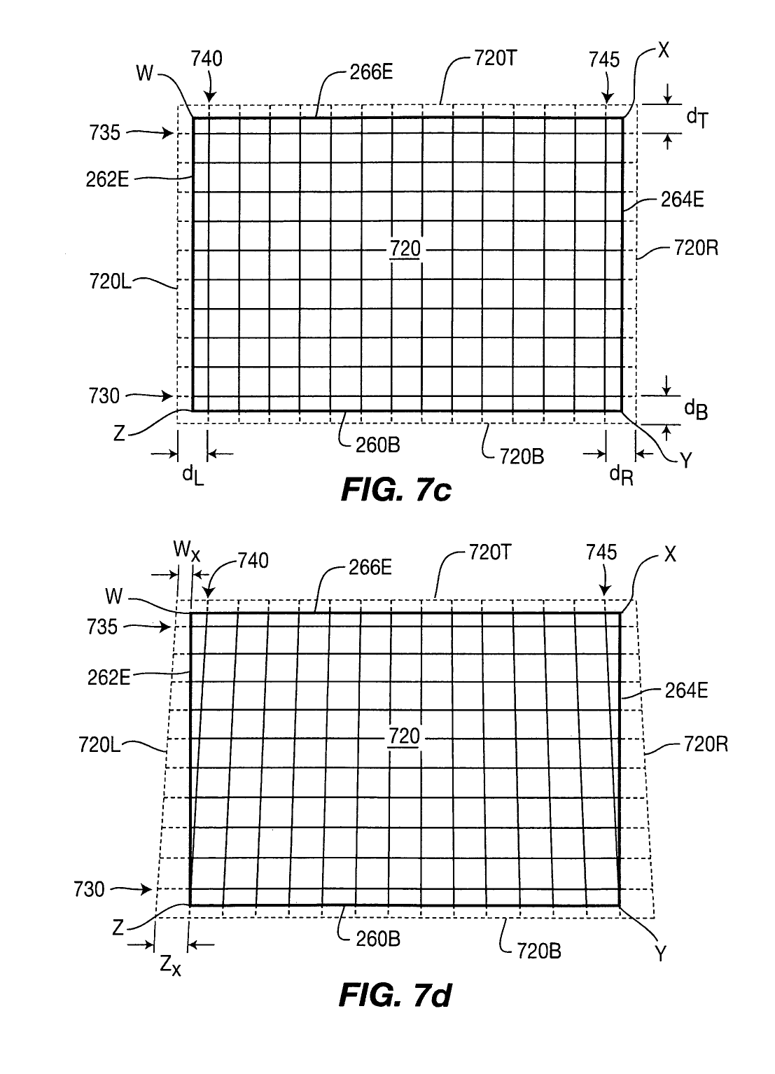

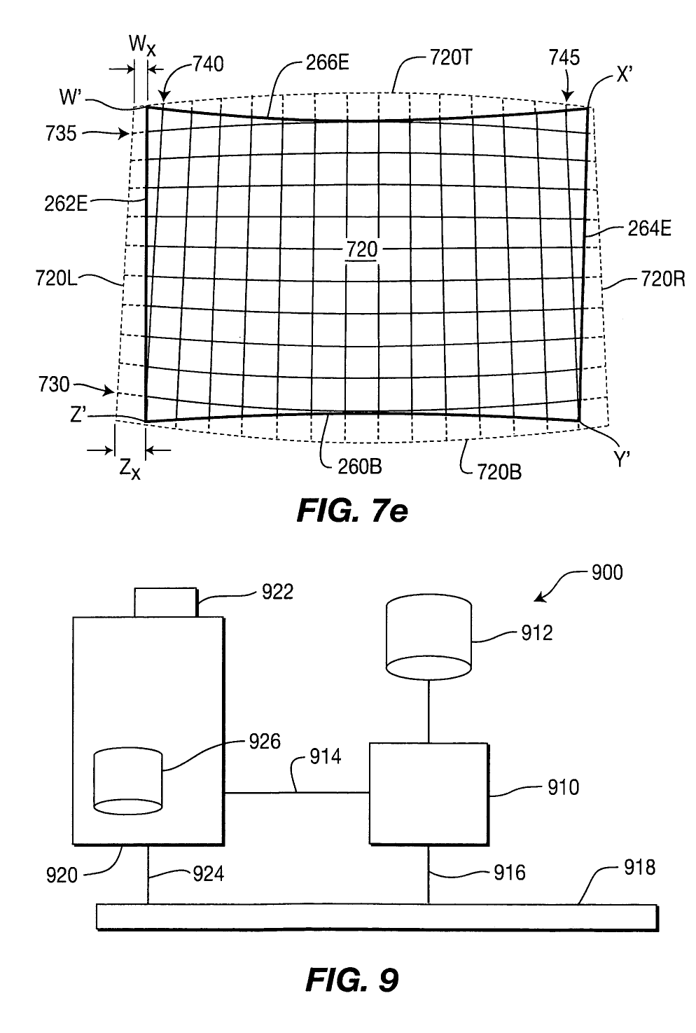

These predetermined or reference values may relate to one or more positions and/or dimensions to be used for displaying the subtitle, e.g., positions for the respective outermost extents, or dimensions such as width or height of the subtitles, or other parameters appropriate for avoiding clipping of subtitles. They are further discussed in conjunction with FIGS. 7a, 7b, 8a, and 8b, which illustrate exemplary methods for determining these reference values or parameters. These reference values are specific to the auditorium 200, e.g., the combination of projection geometry and screen configuration, and implementation of subtitle display based on these parameters will allow subtitles to be displayed within a clear portion of the screen, without the subtitle being cropped.

FIG. 7a shows a test pattern 720 (e.g., as an image data file) that can be used to calibrate the display screen in preparation for subtitle display. In general, the test pattern may be provided for digital projection or display in different ways, e.g., as a digital image file or computationally generated data provided to a projector, or a physical component such as a reticle positioned in the projector. In this example, the test pattern is a Cartesian coordinate grid, with x- and y-axes along the horizontal and vertical directions of the screen 260, and known separations (Δx and Δy, respectively) between adjacent grid lines. In the context of digital media presentation, the unit in the image coordinate system may be expressed as pixel numbers or a percentage of the image's height (for y-coordinate) or width (for x-coordinate). The test pattern 720 has a bottom edge 720B, a top edge 720T, a left edge 720L and a right edge 720R. For example, if the top left corner 722 is chosen as the “origin” of the coordinate system, then the top edge 720T may be assigned a y-coordinate having a pixel number equal to 1, and the left edge 720L may be assigned a x-coordinate value having a pixel number equal to 1. The vertical grid lines will have pixel numbers increasing from left to right, while the horizontal grid lines will have pixel numbers increasing from top to bottom.

The grid line separations, Δx and Δy, which may be expressed as a number of pixels or a percentage of the image width or height, may or may not be equal to each other. Depending on the desired resolution, different values of Δx and Δy may be used in the test pattern. In one example, Δx and Δy are between 5% to 10% of the image width and height, respectively. In another example, the test pattern may provide an exact pixel count measurement (i.e., as individual pixel count, corresponding to about 0.05% of an image width of 2048 pixels). In yet another example, a grid line separation of about 50 to 100 pixels provides a convenient pattern while offering a reasonably fine resolution, especially when coupled with estimation or interpolation by the operator.

In an alternative embodiment, coordinates for grid lines in test pattern 720 may be expressed as pixels or percentage from the nearest parallel edge (i.e., 720T, 720B, 720R, or 720L, whichever is parallel to and nearest to the grid line of interest).

As a part of the calibration procedure, the test pattern 720 is projected at the same projection settings or geometry as would be used for movies to be shown in the auditorium. This pattern 720 provides a measurement grid for determining reference parameters relevant for subtitle display. In other embodiments, different patterns or other coordinate systems may also be used, for example, to better match different geometry or layout of the display screen.

Preferably, some or all grid lines in test pattern 720 are marked by indicia (not shown) to associate each grid line with its defining coordinate. Thus, a vertical grid line 750 may be marked to indicate its horizontal or x-coordinate, which may be expressed in different formats, including, for example, number of image pixels, a percentage of the image width, or just a grid line number (the latter being used with a lookup table that can be accessed by a processor to determine the corresponding horizontal coordinate).

FIG. 7b illustrates the test pattern 720 being shown on screen 260 during a calibration process for determining one or more reference parameters or values useful for subtitle display. In this case, grid line 730 is the lowest horizontal grid line visible on the display area of the screen 260, with the bottom edge 720B being masked off by the screen's bottom edge 260B.

FIG. 7c is another illustration of the grid pattern projection of FIG. 7b, with edges 262E, 264E, 266E of the respective masking and bottom edge 260B of screen 260 shown in bold (remaining portions of the masking omitted for clarity's sake). To facilitate the discussion, the outer portion of the grid pattern projection (i.e., outside the display area of the screen 260, and thus, not visible in the projection configuration of auditorium 250) is also shown as dashed lines.

In this example, grid line 730 may be used to define a reference bottom height or offset (d_{B}) for a subtitle with respect to the pattern's bottom edge 720B. By setting the bottom height of a subtitle to be above the position of d_{B}, the subtitle can be displayed without being clipped by the bottom edge 260B of the screen.

Similarly, a grid line 740, which is the left-most vertical grid line of the pattern projection, can be used to define an offset (d_{L}) for the left-most extent of a subtitle. Another grid line 745, the right-most vertical grid line of the pattern projection, can be used for defining a right edge offset (d_{R}) for the right-most extent of a subtitle. Yet another grid line 735, the top-most grid line, may be used to define a top offset (d_{T}) for the top-most extent of the subtitle. In this example, the edge offsets are defined relative to the respective edges (720L, 720T, 720R and 720B) of the test pattern 720 that are closest to the grid lines, and may be expressed as pixel numbers or a percentage of the image height or width. These edge offsets may also be referred to as position limits, because they serve as limits to the positioning of a subtitle.

In one embodiment, the test pattern 720 has a physical extent, and thus, aspect ratio, that is the same as a known or standard format of a movie, including, for example, two common formats: “scope” with a width-to-height aspect ratio of 2.39, or “flat” with an aspect ratio of 1.85. In this situation, the edge offsets defined for the test pattern 720 will be the same as those defined with respect to the edge of the corresponding movie image. Thus, one may use one test pattern for calibration for movies in a scope format, and another test pattern for those in a flat format.

In another embodiment, however, the test pattern may have an aspect ratio different from the standard format of a movie. For example, the test pattern may be integrated with or built-in to a projector such that the test pattern's physical extent or aspect ratio is determined by the projector's imager (which is an electro-optical device that converts the electrical signals representing image data into optical signals, e.g., a cathode ray tube (CRT) or spatial light modulators such as a liquid crystal display or digital micro-mirror device), independent of movie image formats. In this case, the dimensions or aspect ratio of the test pattern will have a correlation (or correspondence relationship) to those of the imager, e.g., pixels mapping to or substantially matching one or more corresponding pixels on the imager. Calibration will involve obtaining a different set of reference values or parameters for each different masking configuration in an auditorium provided according to the format of a movie, e.g., scope masking, flat masking, among others.

If the reference values from the calibration image are recorded in percentage of image height or width, and the movie image has an aspect ratio that is different from that of the projector's imager, the coordinates or parameters obtained from the test pattern may need to be transformed from the projector's image space to that of the movie image. (Such a coordinate transformation may not be necessary if an anamorphic lens is used in projection so that the aspect ratio of the movie image is computationally stretched or compressed to more closely match the aspect ratio of the imager, thereby utilizing more pixels and obtaining more brightness from the projector, and allowing the anamorphic lens to de-stretch or de-compress the altered axis during projection, so that the movie image appears correctly, i.e., in its original aspect ratio. In this case, the anamorphic lens will also be used for the calibration process.)

The use of the outer-most grid lines 730, 735, 740 and 745 to define respective reference offsets for the outer-most extents of a subtitle is a convenient and relatively quick way of specifying a safe area for displaying the subtitle without clipping. However, this approach may result in a subtitle having an outer-most extent lying just outside this defined area, and yet, still may not suffer any clipping (e.g., if the right edge of the subtitle lies between grid line 742 and the edge 264E of the right masking).

Thus, if a more precise or refined calibration is desired, one may expand the defined area by taking into account the additional distance between each outer-most grid line and the corresponding edge of the masking/screen. For example, the vertical coordinates for the edge 266E of top masking 266 and the bottom edge 260E of screen 260, the horizontal coordinates for the edge 262E of masking 262 and the edge 264E of masking 264 can also be recorded or stored during calibration, and used for defining a rectangle corresponding to the non-clipping area of screen 260.

As an example, if Δx is 5% of the image height and the distance between grid line 730 and the bottom edge 260B of the screen appears to be about ⅓ of Δx, then the coordinate value for the bottom edge 260B can be estimated as the coordinate of grid line 730 plus ⅓ of 5% of the image height. Assuming that the grid line 730 has a coordinate equal to 90% of the image height, with the height measured from the top of the image, then the bottom edge 260B will have a vertical coordinate of 91(⅔)%; which may be rounded off to 91.5% for convenience sake, or 8.5% from the bottom edge of the image. Thus, if the bottom height of any subtitle is less than 8.5% from the bottom edge 720B of the image, the subtitle should be raised (and/or scaled) such that the bottom height of the subtitle is at least 8.5% from the bottom edge of the image.

In one embodiment, the image height of the test pattern 720 is equal to the image height of a typical movie, e.g., in scope or flat format. In another embodiment, the calibration method can be used to prepare subtitles for media presentation on a television (TV) monitor, and the test pattern's aspect ratio matches that of one or more TV standards, e.g., standard definition TV (SD-TV) with an aspect ratio of 1.33 and high definition TV (HD-TV) with an aspect ratio of 1.77.

Aside from the above reference offsets from the edges of the image, other reference parameters relevant for subtitle display may also be defined, e.g., a reference width that can be treated as an upper limit for the width of a subtitle can be defined by the distance or separation between grid lines 740 and 745, or alternatively, by the distance between the edge 262E of masking 262 and the edge 264E of masking 264, both of which can be measured using the projection of the grid pattern 720. Similarly, a reference height may be defined as an upper limit for the height of the subtitle using appropriate grid lines or edges of respective masking or the screen.

Furthermore, the x- and y-coordinates for corners W, X, Y, Z of the non-clipping area of screen 260 (i.e., the portion of screen 260 visible to the audience) can also be recorded, for example, by an operator or projectionist, and/or stored in a memory associated with a digital cinema projector. These corner coordinates (e.g., x- and y-coordinates of one or more corners W, X, Y and Z) may be used for calculating one or more reference parameters or offsets for positioning the subtitles. Alternatively, these coordinates may be considered as reference parameters for defining an area or position for displaying a subtitle. For example, coordinates of two non-adjacent corners such as W and Y may be used to define a rectangular area suitable for subtitle display without cropping. If the edges of the screen/masking are known to define a substantially rectangular area (e.g., each edge being either substantially vertical or horizontal) and the projection of image 720 is substantially without distortion, then the x- and y-coordinates of one corner will be sufficient to define two edge offsets for positioning a subtitle for display.

Although the use of certain grid lines (e.g., the outermost grid lines appearing on the screen, or if desired, other grid lines) provide a convenient way of defining reference edge offsets, other techniques may be used for defining one or more reference offsets to be used for subtitle display, thus allowing for additional flexibility or customization, as needed.

This is shown in an example of FIG. 7d, illustrating another view of the projection of the test pattern 720 of FIG. 7a relative to the screen's display area defined by WXYZ. In this example, the grid lines of pattern 720 are distorted, e.g., by keystoning effect, as may occur with a projector located higher than the center of the screen and the effect is otherwise uncompensated, resulting in the image at the bottom of the screen being magnified more than at the top of the screen. Keystoning results in the projected image of pattern 720 appearing as a trapezoid, with the bottom edge 720B being longer than the top edge 720T, and the vertical grid lines (e.g., grid lines 740 and 745) being at an angle with respect to the vertical edges 262E or 264E of the screen masking.

In this case, outermost vertical grid lines 740 and 745 that are located completely within the sides of the visible screen may still be used to define a reference width (e.g., an upper limit) for a subtitle so that the increased magnification towards the bottom of the projected image does not result in cropping of a subtitle (similar to FIG. 4).

The corner coordinates for W, X, Y and Z can also be used to define a display area or additional reference parameters for displaying subtitles that more closely follow the edges of the visible portion of screen 260. For example, the edge 262E of masking 262, i.e., line WZ defined by coordinates of W and Z, can be used for specifying a reference parameter, e.g., an edge offset with respect to the left edge 720L of pattern 720, for a leftmost extent of a subtitle to be displayed. This left offset will vary as a function of the vertical position due to distortions of the projected grid lines of the test pattern 720, and would thus have a value between the x-coordinate of corner W (Wₓ) and the x-coordinate of corner Z (Zₓ). An alternative way to measure this distortion is discussed below with respect to FIG. 8a.

FIG. 7e shows another view of the projection of the test pattern 720 of FIG. 7a relative to the screen's display area defined by W′X′Y′Z′. In this example, the screen has a concave cylindrical shape, which is often found in premiere theatres so that wide-screen presentations will appear more evenly illuminated. Thus, aside from the keystoning effect, the grid lines of pattern 720 are further distorted due to the curvature of the screen display area W′X′Y′Z′. The distortion to an image induced by a cylindrical screen (as compared to a flat screen) occurs because the throw or distance from the projector to the center of the screen is greater than the distance to the right and left sides, which causes the center of the image to undergo a higher magnification than the left and right sides.

In FIG. 7e, this results in the projected image of test pattern 720 exhibiting barrel-distortion, primarily in the vertical direction such that the test pattern 720 has a projected height that is larger near the center than the left or right sides. Thus, the top-most grid line 735 exhibits an upward bow, while the bottom-most grid line 730 exhibits a downward bow. In addition, the projected bottom edge 720B is longer than projected top edge 720T due to the keystoning effect. Despite these distortions, grid lines 730, 735, 740, and 745 can still be used to define an area or portion of an image suitable for projecting subtitles without cropping. However, a higher quality fit to the visible portion of screen 260 (bounded by the bowed quadrilateral W′X′Y′Z′) may be achieved by specifying additional coordinates for characterizing the curved edges. For example, the curved bottom edge 260B may be characterized by the height or vertical coordinates of corners Z′ and Y′ on projected test image 720, and one or more vertical coordinates towards the center of the screen, e.g., the height of grid line 730. An alternative way to measure this more complex compound distortion is discussed below, with respect to FIG. 8b.

It is understood that the various measurement and/or data entry steps in the calibration method may be done by an operator or projectionist, or by one or more processors configured to execute a calibration program, or a combination thereof.

FIG. 8a shows another embodiment for determining reference parameters relevant for subtitle display, e.g., parameters that relate to the position and/or dimension to be used for displaying a subtitle. In this case, a computer program, e.g., provided by a digital cinema server, allows the use of an interactive image for calibrating a projection screen by determining parameters relevant for subtitle display.

In one example, the projected calibration image 820 includes a geometric shape or figure, e.g., quadrilateral 830, having four corners A (lower left), B (lower right), C (upper right) and D (upper left). The software allows each of the four corners of the projected image 820 to be controlled or manipulated to different positions, e.g., for defining a portion of the screen for displaying a subtitle without clipping. These corners, or other features of the calibration image 820 whose positions are controllable or adjustable by the user, are also referred to as “controls”.

Calibration of the screen for subtitle positioning can be performed by running the test or calibration software. Various parameters or dimensions such as the maximum width (e.g., width 614 in FIG. 6), reference bottom height (e.g., height 512 in FIG. 5), other reference edge clearances or offsets, and so on, can be determined by positioning each of the four corners A, B, C and D of quadrilateral 830 as close to the corresponding corners of screen 260 as possible, without the quadrilateral being clipped by the masking or edges of screen 260. Interactive calibration image 820 preferably further includes a display of an instruction 835 for the current calibration step, so that the calibration procedure can be clearly, conveyed to the operator.

In the scenario of FIG. 8a, the operator has already indicated that corners A, B and C are correctly positioned, and is currently adjusting corner D, which, per instruction 835, can be achieved by manipulating cursor buttons (not shown) and pressing the ENTER button (not shown) when done. When completed, the coordinates of the corners are recorded or stored, and can be recalled at a later time for ensuring that a subtitle of any picture shown with the particular projection geometry, is appropriately transformed, if necessary, to avoid clipping by masking or edges of screen 260. It is understood that different coordinate systems, e.g., image coordinates in pixel numbers, or in percent of image space, can be used for the purpose of obtaining these reference parameters, as long as the measurements are performed consistently in one coordinate system.

Alternatively, quadrilateral 830 may be replaced by another geometric shape, e.g., a rectangle or trapezoid or other suitable shapes, preferably with appropriate instructions displayed on the screen for adjusting the fit of the geometric shape to the clear or unmasked portion of screen 260. The use of different geometric shapes also allows customization of the calibration parameters based on specific application needs.

The resulting control values (i.e., positions or coordinates of the control points A, B, C, D) of the geometric shape 830 adjustment are used to ensure that each subtitle to be projected on screen 260 will fall within the non-clipping region defined by the geometric shape. For example, these control values may be used to determine reference parameters such as edge offsets and/or scaling parameters necessary to modify the subtitle's position and size. Thus, the x- and y-coordinates for the four corners of quadrilateral 830 can be used to derive the maximum widths and heights (or horizontal and vertical extents) for a subtitle to be displayed within the boundaries of the geometric shape—noting that with the quadrilateral 830 entered as shown in FIG. 8a, the maximum height for a vertical subtitle, such as Chinese characters, near the left edge of the screen would be shorter than the maximum height for a vertical subtitle near the right edge of the screen. (Though, after completing the calibration instruction 835, corner D would preferably better match the visible area of the screen 820).

In one embodiment, the calibration program may also compute the edge offsets and/or reference width/height based on these corner coordinates, and the computed results stored for use in modifying a subtitle position, if needed. Alternatively, the corner coordinates from the calibration may be stored in memory, and the computation of one or more reference values or parameters (e.g., edge offsets, maximum dimensions) relevant to the subtitle display can be done shortly before playout of the subtitle. In the latter approach, there are fewer parameters to be stored, which may also facilitate any editing that may be required during a re-calibration process.

Furthermore, the recording of various coordinates or display areas in the calibration procedure may be achieved by using a camera to capture the calibration image (e.g., FIG. 7 or FIG. 8), in which the camera is connected to a computer for storing and/or computing additional parameters.

If desired, an even tighter fit to the projection geometry may be supported by allowing the edges or boundaries of the geometric shape to bow in or bow out to accommodate distortions resembling barrel or pincushion-distortion, with corresponding on-screen instructions for the operator. This is illustrated in FIG. 8b, showing a four-sided geometric FIG. 830′, with corners A′, B′, C′ and D′, respectively. Unlike the quadrilateral 830 in FIG. 8a, the geometric shape 830′ does not necessarily have straight sides or edges. Instead, each side can be manipulated to bow in or bow out, as appropriate. In this illustration, the curvature of the edges can be manipulated by moving respective edge controls 836, 837, 838 and 839, and each edge may be represented by a curve defined by two adjacent corners of the geometric figure and an edge control between the two corners. Thus, not only can each edge be adjusted to bow in and out by moving a control perpendicular to the associated edge, but by moving the control along the edge, the bow can be made asymmetric (e.g., the curvature is not symmetric about a midpoint of the edge), which might be appropriate if the projector is shooting off-axis. Such a definition of the non-clipping or clear area is particularly valuable if the projection screen is curved or keystoning and other projection distortions are present. Again, an instruction 835′ is preferably provided for guiding the operator through the calibration.

In this embodiment, the projected image used for calibration does not include any coordinates or grid pattern because there is no need for the operator to see the coordinates on the image for measurement or calibration purpose. Instead, the positions of various control (including edges, corners, or other features of geometric FIG. 830 or 830′ that can be adjusted or varied by the operator), e.g., expressed as pixels or percentages of image width or height in an image coordinate system, are recorded and processed directly by the calibration program and associated processor. For example, with each click of the cursor keys by the operator, a corner or edge control is stepped in one coordinate or another and the image is updated in the calibration program. The coordinates of the corners and/or other controls (e.g., edge controls) are retained or stored by the program, and the image of geometric FIG. 830 or 830′ is recomputed with each change.

Different options may be used for implementing the calibration, as well as recording or storage of calibration-related results. In one embodiment, measured coordinates or parameters may be stored for use in computing or defining other reference parameters (e.g., edge offsets, maximum width/height of subtitle) at a later stage. In another embodiment, at least one reference parameter is defined based on one or more measured coordinates, and the reference parameter(s) are stored for later use in modifying instructions for positioning the subtitle.

Depending on the screen configuration or layout, reference values or coordinates may be defined for subtitle display with respect to at least one edge of the display area. For example, if a portion of a screen is known to have a configuration that may affect subtitle display, the geometric pattern of FIG. 8b may be used to define one or more reference parameters or coordinates relevant for subtitle positioning proximate that portion of the screen. Thus, if a screen is known to have a bottom edge that is curved and results in excessive bowing (i.e., more than is otherwise anticipated by preparers of theatrical content such as studios), then at least one of the vertical or y-coordinates of corners A′, B′ or edge control 836 may be used for defining a reference parameter or offset for positioning the bottom-most extent of a subtitle in order to avoid clipping of the displayed subtitle. If the other three edges of the screen/masking are configured normally, and that all studio-provided subtitles (e.g., based on other rules and/or standards) would be sufficiently far away from these edges, then only one reference parameter is needed for positioning a subtitle with respect to the misaligned fourth edge.

Although many different reference parameters may be determined from the calibration images described above, in practice, there may be situations in which only one or two reference parameters are sufficient to achieve subtitle display without clipping. Thus, if it is known that certain movies or presentations only have one subtitle appearing on screen at any one time, and the subtitle is positioned at a given portion of the image (e.g., close to the bottom), then only a reference bottom height (i.e., bottom edge offset) and a reference width will be sufficient for implementing subtitle display without clipping by the screen's edge and/or masking.

Alternatively, one may also implement the calibration to cover all potential movies and/or different media formats (which may not be standard), so that all edge offsets and reference widths/heights are determined, regardless of whether they may be necessary.

Similar to the discussion in connection with corner coordinates W, X, Y, Z in FIG. 7d, corners A/A′, B/B′, C/C′ and D/D′ of geometric FIGS. 830/830′ are also useful for defining one or more reference parameters such as an edge offset that may not be constant along an edge, e.g., due to one or more distortions such as keystoning.

In one embodiment, control values (e.g., coordinates of controls such as corners, edge controls) may be used for deriving one or more reference parameters, each of which may be relevant to one or more portions or zones of the area or coordinates defined by the controls. As an example, assume that ABCD in FIG. 8a defines a subtitle display area, and the line CD is selected for defining one or more reference parameters, i.e., a top edge offset, for the topmost extent of a subtitle. Several approaches may be used for defining the top edge offset.

In one case, one may simply choose the y-coordinate of corner D (since corner D has the lowest y-position along CD) as a top edge offset for all subtitle displays, regardless of the position along the x-direction. In another case, one may use the line CD to define a top edge offset that varies along the x-direction, in which case, there may be as many offset values along the x-direction as the number of coordinate or pixel steps (as determined by the resolution in coordinate space).

Alternatively, one may use an intermediate approach, in which several top offset values are defined for corresponding ranges of x-coordinate positions. For example, the line CD may be divided into two zones or ranges of x-coordinate positions, as shown by the intermediate point I. For x-coordinates starting from corner D to before point I, the y-coordinate of corner D may be used as a first top edge offset. For x-coordinates starting from point I to corner C, the y-coordinate of point I is used as a second top edge offset. This zone approach provides additional flexibility by allowing different numbers of reference parameters to be defined according to specific needs.

FIG. 9 depicts a block diagram illustrating one implementation of the present invention. Digital cinema system 900 includes a digital cinema server 910 and a digital cinema projector 920. Digital cinema server 910, which has at least read access to a storage device 912, is configured for reading a composition from storage device 912 and decoding picture and audio essence. Picture essence and timing information relating to the showing of subtitles are provided to digital cinema projector 920 over connection 914, which may be a one-way or two-way communication path. Digital cinema projector 920 generates an image from the picture essence and projects that image through lens 922 onto a screen, e.g., screen 260 in auditorium 250 shown in FIG. 2. Audio essence is provided by digital cinema server 910 to an audio reproduction chain (not shown), which delivers the audio component associated with or accompanying the picture essence to audience 204 in auditorium 250.

In most present day configurations, projector 920 is notified of the presence of corresponding subtitle essence in storage 912 by digital cinema server 910. The notification can be communicated to the projector 920 through network 918, to which both projector 920 and cinema server 910 are connected, e.g., via respective connections 924 and 916. Subsequently, during the playout of a composition, projector 920 fetches upcoming subtitles from server 910 through network 918. However, the system may also be configured so that the notification and/or subtitles can be sent via connection 914.

In the present invention, each subtitle (e.g., subtitle 110) so fetched is checked against the calibration data entered into storage 926 to determine if a transformation of the subtitle, e.g., translation and/or scaling, is required. Any necessary transformation is made before the subtitle is composited with the image formed from the picture essence.

As known to one skilled in the art, a subtitle may be provided in different forms in a subtitle file. If a subtitle is provided in a form of “timed text”, the subtitle will need to be rendered before it can be projected (whether or not composited). However, if the subtitle is provided in a “subpicture” form, it can simply be projected (whether or not composited). In the context of this discussion, it is understood that a projected image of a subtitle refers to both scenarios above, regardless of whether the subtitle is first rendered prior to projection.

FIG. 10 shows a flowchart illustrating a method 1000 for preparing subtitles for display in accordance with embodiments of the present invention. The method starts at step 1002, in which various tasks are performed to prepare a projector and screen prior to a show. Such tasks may include, for example, aligning and focusing the projector, and masking of the projector screen (e.g., masking 262, 264 and 266 in FIG. 1) in accordance with the format of interest, among others.

In calibration step 1004, calibration data relevant to preparing subtitles for display are determined and entered into a storage device 926 associated with the projector, e.g., a local storage medium. As previously described, such calibration data may be obtained by first displaying a test pattern and determining reference parameters (e.g., FIG. 7a,b and discussion), or by manipulating an interactive image or geometric figure (e.g., FIG. 8a,b and discussion) to closely follow the edges of the clear portion of the display screen. Other test images or patterns may also be used for the calibration, including, for example, an image of a subtitle, which may be similar to or different from those to be displayed.

Once the calibration data or reference parameters relevant for subtitle display are saved in storage 926, the projector may be shut down for later use, or a show may be started.

In show start step 1006, server 910 examines the essence elements, e.g., image, audio, subtitle, etc., of a composition in storage 912 and notifies projector 920 of the presence of any subtitle essence. Server 910 also begins to provide picture essence to projector 920 over connection 914.

In subtitle fetch step 1008, projector 920 fetches essence for a subtitle from server 910 over network 918, so that the subtitle can be processed prior to being displayed as part of the composition. In clearance check step 1010, the subtitle is examined or analyzed to determine its corresponding physical extent on the screen, and whether it would lie within the clear area of the screen. Different methods can be used for such an analysis, which is based in part on the reference parameters determined during the calibration step 1004.

In one embodiment, the analysis is performed by examining the subtitle essence for any instructions relating to the alignment or positioning of the subtitle. For example, an instruction may specify that the bottom of the subtitle is to be aligned to a bottom height 122 equal to 5% of the total image height 102. This bottom height (corresponding to the 5% value from the bottom of the image) is then compared to the reference bottom height (from calibration) to determine if the bottom height specified by the instruction is sufficient to avoid subtitle clipping when projected onto the screen. For example, if the 5% bottom height is less than the reference bottom height, then subtitle clipping at the bottom will occur.

If there is more than one instruction in the subtitle file relating to the alignment of other outermost extents and/or dimensions of the subtitle, these other instructions are also examined to determine if the physical extent of the subtitle, if projected on the screen, would lie within the clear portion of the screen, with essentially no clipping. For example, position information such as x- and y-coordinates for the outermost extents (e.g., top, bottom, left and right) of the subtitle may be computed from instructions in the subtitle file. These computed coordinates can be compared to the respective reference offsets stored in storage device 926.

In another embodiment, the analysis in step 1010 can be done by rendering the subtitle into a frame buffer, which is operatively coupled to the projector or server, and the resulting image of the subtitle examined for its physical extent in the frame buffer. Depending on the specific configuration, the subtitle frame buffer may be implemented as a hardware entity, e.g., in the projector, having special compositing properties with respect to the image buffer, or it may be implemented as a software entity in memory, e.g., in the server. This rendering into a frame buffer can be considered a trial rendering onto the screen. If the resulting subtitle is too large or offset, this can be detected and modified or re-rendered, without the drawback of a clipped subtitle having appeared on the screen. In this case, bottom height 122 might be the height of the lowest pixel in the frame buffer that is not transparent, i.e., without being written to or populated by subtitle-related data. This mode is particularly useful if the subtitle essence is of the subpicture type, i.e., the subtitle is a picture of text, rather than instructions for rendering text. This alternative analysis mode is also valuable if the computation of the width or height of a subtitle has resource requirements that are comparable to those for rendering the subtitle. If the subtitle rendering is used in check step 1010, the rendered subtitle is preferably retained for use (e.g., stored in memory) in subsequent steps.

If the subtitle, when projected, would lie completely inside the clear area, then no transformation or modification of the subtitle is needed (i.e., no need to modify any instructions in the subtitle file for displaying the subtitle), in which case, it can be composited into an associated image for display in subtitle composition step 1018.

Different procedures can be used in this clearance check step 1010. For example, it is not necessary that the subtitle be examined for all potential edge violations in a first pass of this step. Instead, one may check for edge violations one edge at a time to see if an outermost extent of the subtitle would lie outside the corresponding reference edge offset. Once an edge violation is detected, information relating to that edge violation can be recorded and/or stored in memory, and processing continues with step 1012. However, one may also choose to examine all edges for violations during the first pass of step 1010, and the information relating to all edge violations can be stored in memory prior to step 1012.

In step 1012, an opposite-edges test is performed to see whether the subtitle would violate the limits imposed by two opposite edges, e.g., top-bottom edges or right-left edges, of the clear area. If the subtitle has previously been subjected to this test step 1012, then an additional rule may also apply, as will be discussed later on. For instance, if the subtitle is found to extend beyond both the left and right edges of the clear area as established by the reference parameters from calibration, i.e., its width exceeds the reference width, shifting the subtitle to the left or right could not remedy the potential clipping. In this case, processing continues with the scaling transformation step 1014.

In an alternative embodiment, dimensions such as the width and height of the subtitle to be displayed may also be computed from the information in the subtitle file to determine if they are less than or equal to the reference width and height obtained from calibration. A comparison of these values can be used to implement opposite-edges violation step 1012.

In the subtitle scaling step 1014, the subtitle is modified to reduce its size sufficiently to eliminate the opposite-edges violation. If the subtitle has been rendered in the frame buffer, the subtitle can be modified by an image reduction in the buffer containing the subtitle. Alternatively, the instructions for rendering the subtitle can be modified, e.g., by specifying a smaller font, or providing a scaling factor. For example, a processor in the projector may be used to compute the scaling factor or determine the reduced font size to be applied. In one embodiment, the scaling factor or the reduced font size is selected so that changes to the subtitle are kept to a minimum, e.g., just enough to reduce the subtitle width (or height) to that of the reference value. The example shown in FIG. 6 illustrates the result of using a scaling factor to produce subtitle 610 with a reduced width 614 that fits within the non-clipping region of screen 260.

In step 1012, if the test results show that there is no opposite-edges violation, e.g., violation involves only two non-opposite edges, or only one edge violation with no history of a previous violation for the opposite edge (i.e., opposite to the currently-violated edge), then the clipping may be resolved by merely shifting the subtitle away from the one or more violated edges. In this case, processing continues with shifting transformation step 1016.

In the subtitle shifting step 1016, the subtitle is translated away from the violated edge by an amount sufficient to eliminate the violation. Although it may be desirable to shift a subtitle by only the minimum amount sufficient to avoid clipping, other factors may also influence the decision of the actual amount to be shifted. For example, if there is more than one subtitle to be displayed, one of the subtitles may need to be shifted by more than a minimum amount in order to accommodate the display of another subtitle. If the subtitle extent violates two non-opposite edges, the shifting can be performed for each edge sequentially, with the specific amount of translation determined based on respective reference offsets for the corresponding edges.

As with the scaling transformation of step 1014, this can be achieved by modifying a rendered image of the subtitle, e.g., by shifting the image of the subtitle within the frame buffer; or by altering the instructions for rendering the subtitle, e.g., by increasing the bottom height to a value at least equal to the reference or threshold bottom height (e.g., height 512 in FIG. 5).

After at least one of a scaling or shifting transformation has been performed in step 1014 or 1016, respectively, processing returns to clearance check step 1010. The physical extent of the transformed subtitle (either by modifying the display instruction or the subtitle image rendered in the frame buffer) is also referred to as a modified physical extent. If the transformed subtitle would no longer suffer substantial clipping, processing continues at step 1018, in which the subtitle is composited into an associated image for display. Depending on specific application needs, different criteria may be used in the clearance test for determining the amount of clipping that may be acceptable. In one embodiment, the clearance test requires the physical extent of the subtitle, when projected, to completely fit inside the clear area of the screen. In another embodiment, a small amount of clipping, e.g., specified as a given number of pixels, may be considered acceptable, if the clipping will not affect the audience's comprehension of the subtitle.

If the clearance check step 1010 shows that clipping (according to an established criterion) is still present, then the opposite edge test step 1012 is repeated for the transformed or modified subtitle. If the opposite-edges test is being done for at least a second time on the same subtitle, then a different rule will also apply: specifically, if a single edge is currently being violated and its opposite edge was violated in a previous pass, then the opposite-edges test step 1012 will return a “yes”.

In other words, the opposite-edges test includes the following two inquiries:
1) whether two opposite edges are currently violated;
2) if only one edge is currently violated, was the opposite edge involved in a single-edge violation in a previous test?

If the answer to either of these two questions is “yes”, then the opposite-edges test will return a “yes”, in which case, the process will proceed to the scaling step 1014.

As an example, assume that in a first pass, step 1012 indicates that a subtitle has violated the left edge of a quadrilateral representing the non-clipping region of screen 210, and the subtitle is translated to the right in step 1016. In a second pass, when the translated subtitle is returned to step 1012, it is found to violate the right edge of the quadrilateral. The solution in this case is not to translate it towards the left, but instead, to shrink the width of the subtitle by processing in step 1014.

Since it may be desirable that the subtitle be displayed as closely as possible to the original specifications, e.g., font size, position and/or aspect ratio, the scaling and/or translation are generally performed in small increments, preferably only to the extent required to provide an unobstructed or unclipped display of the subtitle.

In another embodiment, the method may also include a hierarchy or priority rule, which specifies the order in which different modifications are to be made. For example, a priority rule may specify that the size of the subtitle be reduced before translation is to be done. Thus, if a subtitle is found to violate an opposite-edges test, it will first be transformed using a scaling factor that is sufficient to reduce its width to the reference width. If the scaled-down subtitle still extends beyond the clear display area, then a second transformation will be performed to re-position the scaled subtitle to within the clear display area.

Alternatively, one can also use a one-step procedure in which a more aggressive scaling factor is used to reduce the subtitle width below the reference width, e.g., by an amount that is also sufficient to avoid any other edge violation so that there is no need for translating the modified subtitle. While such a procedure may be more efficient from a computational viewpoint, the two-step procedure (using minimal scaling combined with translation) may be preferable since it may better preserve the original artistic intent.

When clearance test 1010 has determined that the subtitle will not be clipped, the subtitle may be composited into the corresponding image in compositing step 1018. If the subtitle has been previously rendered, the rendered subtitle may be used. Otherwise, the subtitle is rendered for the compositing step 1018.

In test step 1020, a check is made by the system (e.g., processor in the projector) as to whether there are more subtitles to be prepared or processed for display. If so, safe subtitle display process 1000 loops back to the fetching step 1008. Otherwise, process 1000 concludes at end step 1022.

Since the calibration data obtained for a given combination of screen and projector configurations in the auditorium (e.g., dimensions and shapes of screen and masking, projection geometry, among others) remain valid from day to day, the calibration step 1004 may be skipped in subsequent implementation of safe subtitle display process 1000, even for different shows, as long as the screen and projector configurations remain unchanged.

Safe subtitle display process 1000 may also be used to simultaneously display multiple subtitles (e.g., different languages), any of which might lie partially outside the non-clipping region. In this case, the collection of multiple subtitles can be treated as a single subtitle, for example, by rendering all of them together into the same frame buffer and using the union of their collective extents as the extent of a single subtitle.

In an alternative embodiment in which multiple subtitles are to be simultaneously displayed (e.g., in the same sequence of frames), the amount of translation or shifting applied to one subtitle in step 1016 is applied to all subtitles that would be simultaneously displayed. Similarly, the magnitude of the scaling applied to one subtitle in step 1014 is also applied to all the other subtitles to be simultaneously displayed.

In yet another embodiment, the translation and/or scaling is applied to one or more subtitles individually or independently, e.g., only some of the subtitles may be shifted and/or scaled, or different subtitles may be scaled and/or translated by different amounts. In such a scenario, it is possible that the translation of a first subtitle may cause a “collision” with a second subtitle, i.e., the shifted first subtitle may have a physical extent that intersects or overlaps with that of another subtitle.

Thus, the subtitle display procedure can be adapted to include a step for detecting and avoiding a potential collision, e.g., by translating the second subtitle by an appropriate amount. In one embodiment, the system can be configured such that the projector can query the server for all subtitle files whose subtitles are to be displayed within certain common time periods in one composition. These subtitle files are then delivered by the server such that all the subtitle-related information (i.e., files containing subtitle essence, position and display information) are available to the projector for use during the process of FIG. 10.

As an example, the information of two subtitle files may be used to determine physical extents of the two subtitles. If one of the subtitles requires a translation because its physical extent (when projected) lies outside the defined area for display, its modified physical extent would be compared to the physical extent of the other subtitle. If an overlap exists between the two subtitles, then the second subtitle would be transformed (e.g., translated and/or scaled) so that its modified physical extent would not overlap with that of the first subtitle, and yet, still lie within the defined area for display.

In various alternative embodiments, steps 1010, 1012, 1014, 1016 of subtitle display method 1000 may be performed by either server 910 or projector 920 alone, or by server 910 and projector 920 in conjunction with each other. If performed by server 910, the subtitle essence provided to projector 920 will already be transformed to result in substantially no clipping of subtitles. In such an implementation, storage 926 for retaining the data representative of the non-clipping area of screen 210 can be located in server 910.

In still another embodiment, storage 926 may be connected externally to server 910, similar to storage 912. In such a configuration, server 910 may communicate data representative of the non-clipping area of screen 210 to projector 920 through network 918, or server 910 may perform any necessary transformations to the subtitle essence before passing it on to projector 920.

In yet another embodiment, compositing step 1018 may be performed by server 910 such that a complete image or composition, e.g., composition 100, 500 or 600 (with picture 120 and respective subtitles 110, 510 or 610 fully rendered and composited), is provided to projector 920 by server 910, preferably through connection 914.

As previously discussed, the transformation of a subtitle may be produced by at least one of shifting or scaling transformation by repeated passes through the opposite-edges test step 1012 and transform steps 1014 and 1016.

In an alternative embodiment, a subtitle may be shifted and scaled in a single superposed transformation in a single pass. When such a superposed transform is used, it may not be necessary to repeat non-clipping test 1010 after a transformation, and process 1000 may proceed to compositing step 1018 following the transformation.

In still another alternative embodiment, a subtitle may be warped, i.e., the amount by which the subtitle is shifted and/or scaled varies (preferably without visible discontinuities) throughout the extent of the subtitle. This embodiment is particularly valuable in auditoriums having cylindrical screens as discussed above in conjunction with FIG. 7e. In FIG. 7e, a subtitle with horizontal text at the bottom of the image will not be clipped by screen bottom 260B if it is shifted to at least the height of grid line 730. However, to an audience, screen bottom 260B would likely be perceived as “true” (i.e., undistorted), and a subtitle extending along the grid line 730 may be perceived as “smiling”, i.e., curling upwards at either end. By shifting and/or scaling each region or part of the subtitle by differing amounts (e.g., as little as the height of corners Z′ or Y′, or as much as the height of grid line 730) depending on the horizontal locations of the screen at which different parts of the subtitle are to appear, a subtitle can be made to more closely follow the lower edge 260B of the visible screen area 260. Such a “warp” function is preferably continuous and smoothly varying, and in some cases (such as the keystoning shown in FIG. 7d), may be implemented as an affine transform, e.g., one that preserves collinearity and ratios of distances. In one embodiment, a warp function is defined dynamically for each subtitle, such that the required modifications can be minimized, e.g., the subtitle is modified by an amount just sufficient to allow its display in the clear area of screen 260 without clipping.

In another embodiment, a master warp function can be defined based on one or more reference parameters measured from calibration, and respective warp values at various locations (on the screen or image space) can be computed and subsequently applied to all subtitles. Such a master warp function may be defined as a transform that, when applied to a subtitle provided within an industry standard “title safe area” observed by content producers, is sufficient to ensure that the subtitle will be projected within the visible portion of the screen 260.

Such warping of subtitles can occur after the subtitles have been rendered, but before they are composited with the movie's image, or the warp can be provided to the subtitle rendering process so that timed text subtitles are rendered as warped subtitles.

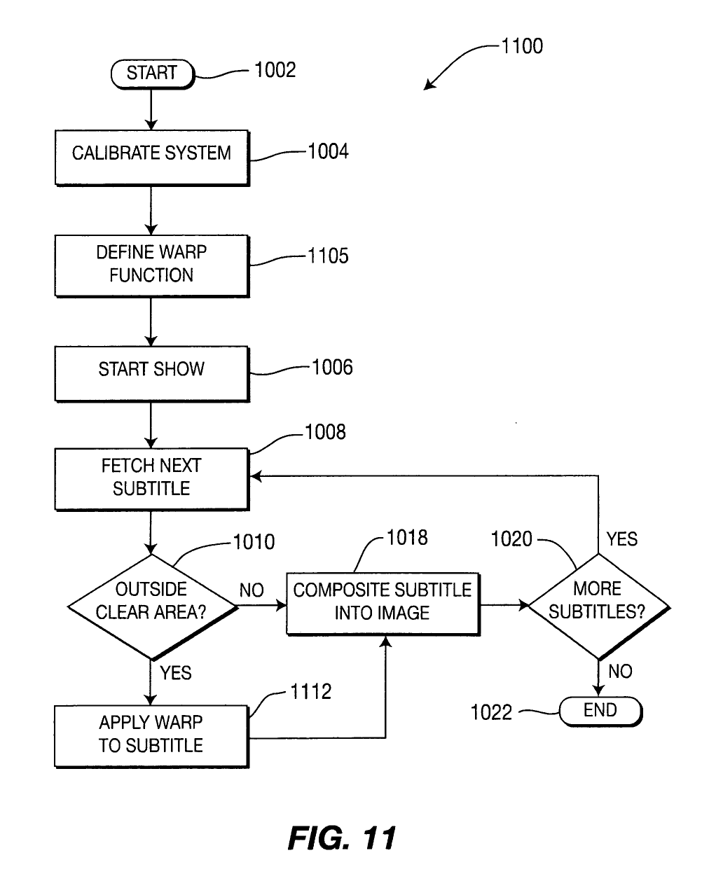

FIG. 11 illustrates a method 1100 that incorporates the use of a warp function for preparing subtitles for display. Method 1100 is a variation of method 1000 of FIG. 10, and includes many steps that are previously discussed. In this case, however, after the calibration step 1004, a warp function (or transformation function) is defined based on at least one reference parameter obtained from the calibration, as shown in step 1105. Optionally, warp values corresponding to different locations of the screen may be computed at this time and stored for later use. The start of show, subtitle fetching and clearance check are performed respectively in steps 1006, 1008 and 1010 as previously described in method 1000.

If the clearance check step 1010 indicates that a subtitle does not lie outside the clear display area, the subtitle can be composited into a movie's (or a presentation) image, as shown in step 1018.

However, if the clearance check step 1010 indicates that any portion of a subtitle lies outside the clear display area, the method proceeds to step 1112, in which the warp function is invoked. Warp values corresponding to various locations are computed (if not already done) from the warp function and applied to the subtitle. Alternatively, if warp values have been computed prior to this step (e.g., during or after step 1105), then they can be directly applied to the subtitle in step 1112.

The modified or warped subtitle can then be composited into the presentation's image, as shown in step 1018. The method 1100 continues to steps 1020 and 1022, as previously described for method 1000.

In yet another embodiment, clearance check step 1010 may be skipped. In that case, for each subtitle fetched in step 1008, warp values are applied in step 1112, and the resulting warped subtitle is composited into the image in step 1018. Although this approach would result in certain subtitles being modified unnecessarily (e.g., the original subtitles are within the clear display area), it is also easier to implement because of simpler logic.

Although the above examples are illustrated for subtitle displays in the context of digital cinema presentations, one or more principles discussed herein may also be adapted for displaying subtitles—or more generally, any texts and/or images, without cropping in different digital media formats or venues, including other display or home entertainment systems. For example, any suitable image shown on a display monitor or video projector can be used for determining one or more parameters relevant to the display of text and/or graphic images without cropping. Additional hardware components such as one or more processors, memories, and so on, may be used in conjunction with (or be added to) a display system for implementing one or more embodiments of the present principles.

Thus, a system may generally include a display means (e.g., screens, monitors, and so on), means for determining at least one parameter to be used for displaying a subtitle, the determining means including an image for display on the display means, and means for preparing the subtitle for display based on the at least one parameter. Depending on the specific system, the means for determining parameters(s) and means for preparing subtitle display may include one or more components such as projector, software, processor, memory, among others.

One advantage of implementing subtitle display according to one embodiment of the present principles is that the subtitle can be re-positioned by a relatively small amount, which can be customized during calibration. Such an approach is less intrusive compared to other techniques that require subtitles to be placed at specific or pre-defined locations, which may require translating the subtitle by an amount larger than desirable for preserving the original artistic intent. The present approach is also sufficiently flexible to allow for the display of multiple subtitles under different constraints.

While the forgoing is directed to various embodiments of the present invention, other and further embodiments of the invention may be devised without departing from the basic scope thereof. As such, the appropriate scope of the invention is to be determined according to the claims, which follow.

1. A method for use in subtitle display, comprising:
determining at least one parameter from a first image displayed on a screen, the at least one parameter relating to one of a position and dimension to be used for displaying a first subtitle; and
preparing the first subtitle for display on the screen based on the at least one parameter.

2. The method of claim 1, wherein the first image comprises a pattern different from the first subtitle.

3. The method of claim 1, wherein the position is a display position of an outermost extent of the first subtitle.

4. The method of claim 1, wherein the dimension relates to one of a width and height of the first subtitle.

5. The method of claim 1, further comprising:
determining at least two parameters from the first image;
generating at least one instruction for displaying the first subtitle based on the at least two parameters; and
displaying the subtitle according to the at least one instruction, wherein the first subtitle is displayed without being cropped.

6. The method of claim 1, wherein the first image includes at least one of a coordinate grid and a geometric figure.

7. The method of claim 6, further comprising:
providing a program for manipulating corners of the geometric figure to different positions on the screen;
wherein the geometric figure is a quadrilateral for defining an area of the screen for subtitle display.

8. The method of claim 6, further comprising:
using the first image to define an area of the screen for subtitle display; and
determining if a physical extent of the first subtitle will be displayed within the defined area of the screen.

9. The method of claim 8, further comprising:
if the physical extent of the first subtitle will not be displayed within the defined area of the screen, modifying at least one subtitle display instruction to generate a modified physical extent for the first subtitle.

10. The method of claim 9, further comprising:
determining whether the modified physical extent of the first subtitle overlaps with a physical extent of a second subtitle to be displayed.

11. The method of claim 10, further comprising:
if the modified physical extent of the first subtitle overlaps the physical extent of the second subtitle to be displayed, modifying at least a subtitle display instruction to generate a modified physical extent of the second subtitle that does not overlap with the modified physical extent of the first subtitle.

12. The method of claim 1, further comprising:
defining a transformation function based on the at least one parameter, the transformation function being dependent on locations of the screen; and
the preparing step further comprises applying the transformation function to the subtitle.

13. An apparatus, comprising:
a screen;
a projector;
a first image for displaying on the screen for determining at least one parameter, the at least one parameter relating to at least one of a position and a dimension to be used for displaying a first subtitle on the screen; and
a processor for preparing the first subtitle for display on the screen based on the at least one parameter.

14. The apparatus of claim 13, wherein the first image comprises a pattern different from the first subtitle.

15. The apparatus of claim 13, wherein the first image is one of a coordinate grid and a geometric figure.

16. The apparatus of claim 15, wherein the first image is used for defining an area of the screen for subtitle display.

17. The apparatus of claim 16, wherein the processor is further configured for:
receiving a first subtitle file containing at least one subtitle display instruction and determining a physical extent of the first subtitle; and
generating a modified subtitle display instruction for the first subtitle if the physical extent of the first subtitle lies outside the defined area of the screen for subtitle display.

18. The apparatus of claim 17, wherein the processor is further configured for:
receiving a second subtitle file containing at least one subtitle display instruction for determining a physical extent of a second subtitle to be displayed;
modifying the at least one subtitle display instruction for the second subtitle to generate a modified physical extent of the second subtitle;
wherein the modified physical extent of the second subtitle does not overlap with the modified physical extent of the first subtitle.

19. The apparatus of claim 13, wherein the dimensions of the first image correlate with dimensions of an imager in the projector.

20. An apparatus, comprising:
a display means;
means for determining at least one parameter relating to at least one of a position and a dimension to be used for displaying a subtitle, the determining means including an image for display on the display means; and
means for preparing the subtitle for display based on the at least one parameter.
